(19) United States
(12) Patent Application Publication
(10) Pub. No.: US 2011/0007190 A1
(43) Pub. Date: Jan. 13, 2011

(54) ILLUMINATION MODULE AND PORTABLE ELECTRONIC DEVICE USING THE SAME

(76) Inventor: Yi-Yuan TSAI, HsinChu (TW)

Correspondence Address: Muncy, Geissler, Olds & Lowe, PLLC, 4000 Legato Road, Suite 310, FAIRFAX, VA, 22033, US

(21) Appl. No.: 12/605,015

(22) Filed: Oct. 23, 2009

(30) Foreign Application Priority Data
Jul. 10, 2009 (TW) 98212623

(51) Int. Cl. H04N 5/262; G03B 15/02; H04N 5/222

(52) U.S. Cl. 348/240.3; 362/16; 348/E05.024; 348/E05.055; 348/E05.045; 348/370; 348/E05.022

(57) ABSTRACT

An illumination module and a portable electronic device using the same are provided. The illumination module comprises a shell, a light source and an optical lens. The shell has an opening, the light source is disposed within the shell to provide an illumination beam transmitted through the opening, and the optical lens is disposed within the shell and in a transmission path of the illumination beam. A power source is applied to the optical lens to adjust a reflective index of the optical lens, so as to adjust an irradiation angle of the transmitted illumination beam transmitted through the optical lens.

### FIELD OF THE INVENTION

The present invention generally relates to an illumination module, and more particularly to an illumination module and a portable electronic device using the same, wherein an irradiation angle of an illumination beam provided by the illumination module is adjustable.

### DESCRIPTION OF THE RELATED ART

With the development of science and technology, portable electronic devices with photography function, such as digital cameras (DC), digital video cameras (DV) and camera cell phones, have been becoming increasingly popular. So far, more and more portable electronic devices are equipped with a zoom lens, so as to be used for shooting pictures with different visual images by simply adjusting a focal distance of the zoom lens.

It is noted that although some portable electronic devices may have a built-in photoflash designed as the zoom lens that can be zoomed in to a wide end, the irradiation angle of the illumination beam provided by the built-in photoflash is un-adjustable. Hence, the illumination beam is not possibly focused on a photographed object when the zoom lens is zoomed out to a tele end to waste part of the illumination beam. Further, when the photographed object is far from the portable electronic device to be underexposed, the image of the object will be too dark to be clearly recognized.

Furthermore, some external photoflashes adjust the irradiation angles of the illumination beams by adjusting a relative position between the light source and the reflector, or between the light source and the optical lens. However, an adjusting mechanism used in the external photoflashes is not only more complicated but also requires larger assembly space. Therefore, the adjusting mechanism is not suitable to be applied in the built-in photoflash.

### SUMMARY OF THE INVENTION

The present invention is directed to an illumination module with an adjustable reflective index of an optical lens.

The present invention is further directed to a portable electronic device with an adjustable irradiation angle of an illumination beam.

An illumination module proposed by the present invention comprises a shell, a light source and an optical lens. The shell has an opening and the light source is disposed within the shell to provide an illumination beam transmitted through the opening. The optical lens is disposed within the shell and in a transmission path of the illumination beam. A power source is applied to the optical lens to adjust a reflective index of the optical lens, so as to adjust an irradiation angle of the transmitted illumination beam transmitted through the optical lens.

In an aspect, the optical lens is a liquid lens. The power source is used to adjust a liquid surface curvature of the liquid lens.

In another aspect, the optical lens is a liquid crystal lens. The power source is used to adjust rotation angles of liquid crystal cells of the liquid crystal lens.

In another aspect, the light source is a xenon lamp tube.

In another aspect, the shell comprises a frame, a light distribution plate and a reflector. The opening is formed on the frame. The optical lens is disposed within the opening, the light distribution plate is disposed at a side of the frame to cover the opening, the reflector is disposed at another side of the frame opposite to the light distribution plate, and the light source is disposed within the reflector.

In another aspect, the reflector comprises a dented portion and a plurality of expansion portions. The light source is disposed within the dented portion, and the expansion portions expand outwards from the dented portion to the frame.

In another aspect, the light distribution plate is a Fresnel lens.

A portable electronic device proposed by the present invention comprises a case, a zoom lens and an illumination module. The zoom lens and the illumination module are assembled in the case. The illumination module comprises a shell, a light source and an optical lens, wherein the shell has an opening. One side of the case exposes the zoom lens and the opening and the light source is disposed within the shell to provide an illuminate beam transmitted through the opening. The optical lens is disposed within the shell and in a transmission path of the illumination beam. A power source is applied to the optical lens to adjust a reflective index of the optical lens, so as to adjust an irradiation angle of the transmitted illumination beam transmitted through the optical lens according to a focus situation of the zoom lens.

In another aspect, the optical lens is a liquid lens. The power source is used to adjust a liquid surface curvature of the liquid lens.

In an aspect, the optical lens is a liquid crystal lens. The power source is used to adjust rotation angles of liquid crystal cells of the liquid crystal lens.

In another aspect, the light source is a xenon lamp tube.

In another aspect, the shell comprises a frame, a light distribution plate and a reflector. The opening is formed on the frame, the optical lens is disposed within the opening, the light distribution plate is disposed at a side of said frame to cover the opening, the reflector is disposed at another side of the frame opposite to the light distribution plate and the light source is disposed within the reflector.

In another aspect, the reflector comprises a dented portion and a plurality of expansion portions. The light source is disposed within the dented portion and the expansion portions expand outwards from the dented portion to the frame.

In another aspect, the light distribution plate is a Fresnel lens.

In another aspect, the portable electronic device includes but not limited to a digital camera, a digital video camera or a camera cell phone.

In another aspect, the transmitted illumination beam transmitted through the optical lens has a first irradiation angle when the zoom lens is zoomed in to a wide end and a second irradiation angle when the zoom lens is zoomed out to a tele end. The first irradiation angle is larger than the second irradiation angle.

In the present invention, the reflective index of the optical lens is adjustable and can be adjusted by a power source. As a result, the irradiation angle of the transmitted illumination beam transmitted through the optical lens can be adjusted according to users' requirements.

### BRIEF DESCRIPTION OF THE DRAWINGS

FIG. 1 illustrates a structure of an illumination module according to an embodiment of the present invention.

FIG. 2 illustrates a structure of a portable electronic device according to an embodiment of the present invention.

### DETAILED DESCRIPTION OF THE INVENTION

Reference will now be made in detail to specific embodiments of the present invention. Examples of these embodiments are illustrated in the accompanying drawings.

While the invention will be described in conjunction with these specific embodiments, it will be understood that it is not intended to limit the invention to these embodiments. In fact, it is intended to cover alternatives, modifications, and equivalents as may be included within the spirit and scope of the invention as defined by the appended claims. In the following description, numerous specific details are set forth in order to provide a through understanding of the present invention. The present invention may be practiced without some or all of these specific details. In other instances, well-known process operations are not described in detail in order not to obscure the present invention.

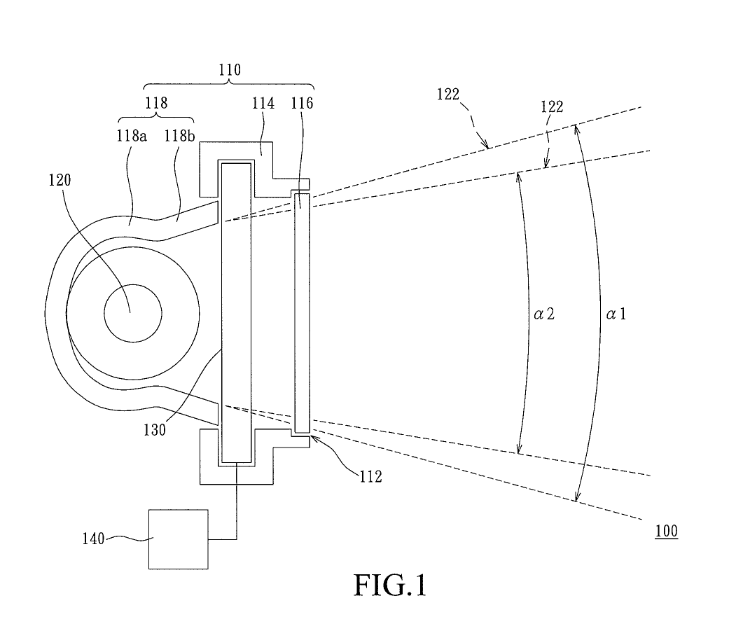

FIG. 1 illustrates a structure of an illumination module according to an embodiment of the present invention. Referring to FIG. 1, the illumination module 100 comprises a shell 110, a light source 120 and an optical lens 130. The shell 110 has an opening 112 and the light source 120 is disposed within the shell 110 to provide an illumination beam transmitted through the opening 112. The optical lens 130 is disposed within the shell 110 in a transmission path of the illumination beam 122. A power source 140 is applied to the optical lens 130 to adjust a reflective index of the optical lens 130, so as to adjust irradiation angles α1, α2 of the transmitted illumination beam 122 transmitted through the optical lens 130.

In the present embodiment, the light source 120 includes but not limited to a xenon lamp tube and the shell 110 may comprise a frame 114, a light distribution plate 116 and a reflector 118. The opening 112 is formed on the frame 114, and the optical lens 130 is disposed within the opening 112. The light distribution plate 116, such as a Fresnel lens, is disposed at a side of the frame to cover the opening 112 to enhance the uniformity of the illumination beam 122. The reflector 118 is disposed at another side of the frame 114 opposite to the light distribution plate 116, and comprises a dented portion 118a and a plurality of expansion portions 118b that expand from the dented portion 118a to the frame 114. The light source 120 is disposed within the dented portion 118a. As a result, light beams provided by the light source 120 are reflected to the opening 112 by the reflector 118 to form the illumination beam 122, and the transmitted illumination beam 122 transmitted through the optical lens 130 and the light distribution plate 116 is transmitted to outside of the shell 110 more uniformly.

The optical lens 130 may be a liquid lens, a liquid crystal lens or any kind of optical lens, which can be applied a power source to adjust a reflective index thereof. As a result, the irradiation angles α1, α2 of the transmitted illumination beam 122 transmitted through the optical lens 130 can be adjusted according to users' requirement. In an embodiment, a liquid surface curvature of the liquid lens can be adjusted by the power source. In another embodiment, rotation angles of liquid crystal cells of the liquid crystal lens can be adjusted by the power source. Hence, the power source can be used to adjust the reflective indexes of the liquid lens and the liquid crystal lens. Accordingly, the irradiation angles α1, α2 of the transmitted illumination beam 122 transmitted through the optical lens 130 can be adjusted according to users' requirement.

For example, the illumination module 100 is used as a photoflash, and operated with a zoom lens together. The irradiation angles α1, α2 of the transmitted illumination beam 122 transmitted through the optical lens 130 can be adjusted according to a focus situation of the zoom lens. Hence, the illumination beam 122 sufficiently illuminates on the photographed object regardless whether the zoom lens is zoomed in to a wide end, or zoomed out to a tele end. For better understanding of the usage of the present invention, the following embodiment is provided for illustrating how to use the illumination module 100 as a photoflash, and how the illumination module 100 to be operated together with a zoom lens. It should be noted that the present invention is not limited to the following embodiment.

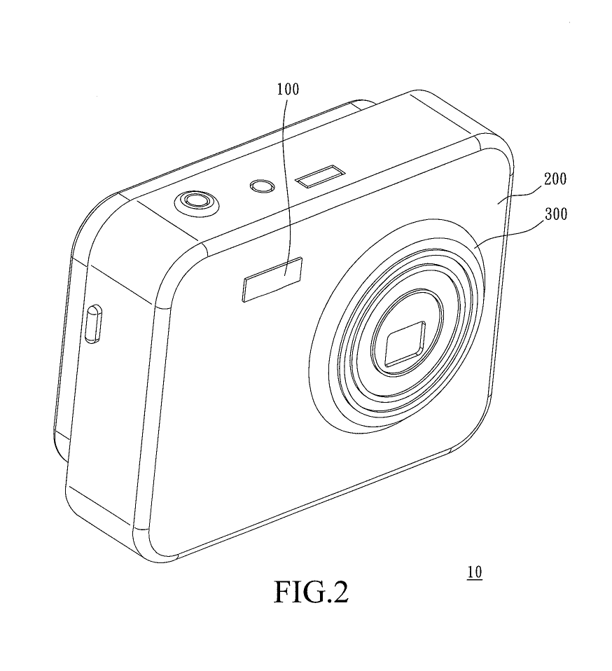

FIG. 2 illustrates a structure of a portable electronic device according to an embodiment of the present invention. Referring to FIG. 1 and FIG. 2, the portable electronic device 10 can be any kind of portable electronic device with a zoom lens, such as a digital camera, a digital video camera or a camera cell phone. The portable electronic device 10 comprises a case 200, a zoom lens 300 and the illumination module 100, which has been illustrated in the previous embodiment. The illumination module 100 and the zoom lens 300 are assembled in the case 200, and a front surface of the case 200 exposes the opening 112 of the illumination module 100 and the zoom lens 300, as illustrated in the FIG. 1. The details of the illumination module 100 have been explained above, and are omitted herein.

The power source 140 is applied to the optical lens 130 to adjust the reflective index of the optical lens 130, so as to adjust the irradiation angles α1, α2 of the transmitted illumination beam 122 transmitted through the optical lens 130 according to a focus situation of the zoom lens 300. Hence, the illumination beam 122 sufficiently illuminates on the photographed object regardless whether the zoom lens 300 is zoomed in to a wide end, zoomed out to a tele end or zoomed in/out between the wide end and the tele end.

For an example, for a broader photographed object, the zoom lens 300 is zoomed in to the wide end. The power source 140 adjusts the reflective index of the optical lens 130 to allow the transmitted illumination beam 122 transmitted through the optical lens 300 to have a wider irradiation angle α1. Hence, the broader photographed object is sufficiently exposed by the illumination beam 122. For another example, for a far photographed object, the zoom lens 300 is zoomed out to the tele end. The power source 140 adjusts the reflective index of the optical lens 130 to allow the transmitted illumination beam 122 transmitted through the optical lens 300 to have a narrower irradiation angle α2. Hence, the far photographed object is also sufficiently exposed by the illumination beam 122.

It is emphatically noted that the irradiation angles α1, α2 of the transmitted illumination beam 122 transmitted through the optical lens 130 can be easily adjusted by using the power source 140 to control the reflective index of the optical lens 130. Compared to the conventional external photoflashes, neither a complicated adjusting mechanism nor an additional assembly space is needed when the illumination module 100 is applied to the portable electronic device 10.

In summary, for an illumination module proposed in the present invention and a portable electronic device using the illumination module, a power source can be applied to the optical lens to adjust the reflective index of the optical lens, so as to adjust the irradiation angle of the transmitted illumination beam transmitted through the optical lens. Neither a complicated adjusting mechanism nor an additional assembly space is needed to the illumination module.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. An illumination module, comprising:
a shell having an opening;
a light source disposed within said shell to provide an illumination beam transmitted through said opening; and
an optical lens disposed within said shell and in a transmission path of said illumination beam, wherein a power source is applied to said optical lens to adjust a reflective index of said optical lens, so as to adjust an irradiation angle of a transmitted illumination beam transmitted through said optical lens.

2. The illumination module as claimed in claim 1, wherein said optical lens is a liquid lens and said power source is used to adjust a liquid surface curvature of said liquid lens.

3. The illumination module as claimed in claim 1, wherein said optical lens is a liquid crystal lens and said power source is used to adjust rotation angles of liquid crystal cells of the liquid crystal lens.

4. The illumination module as claimed in claim 1, wherein said light source is a xenon lamp tube.

5. The illumination module as claimed in claim 1, wherein said shell comprises:
a frame, wherein said opening is formed on said frame and said optical lens is disposed within said opening;
a light distribution plate disposed at a side of said frame to cover said opening; and
a reflector disposed at another side of said frame opposite to said light distribution plate, wherein said light source is disposed within said reflector.

6. The illumination module as claimed in claim 5, wherein said reflector comprises:
a dented portion, wherein said light source is disposed within said dented portion; and
a plurality of expansion portions expansion outwards from said dented portion to said frame.

7. The illumination module as claimed in claim 5, wherein said light distribution plate is a Fresnel lens.

8. A portable electronic device, comprising:
a case;
a zoom lens assembled in said case; and
an illumination module assembled in said case, wherein said illumination module comprises:
a shell having an opening, wherein said zoom lens and said opening are exposed out of a side of said case; and
a light source disposed within said shell to provide an illumination beam transmitted through said opening; and
an optical lens disposed within said shell and in a transmission path of said illumination beam, wherein a power source is applied to said optical lens to adjust a reflective index of said optical lens, so as to adjust an irradiation angle of a transmitted illumination beam transmitted through said optical lens according to a focus situation of said zoom lens.

9. The portable electronic device as claimed in claim 8, wherein said optical lens is a liquid lens and said power source is used to adjust a liquid surface curvature of said liquid lens.

10. The portable electronic device as claimed in claim 8, wherein said optical lens is a liquid crystal lens and said power source is used to adjust rotation angles of liquid crystal cells of said liquid crystal lens.

11. The portable electronic device as claimed in claim 8, wherein said light source is a xenon lamp tube.

12. The portable electronic device as claimed in claim 8, wherein said shell comprises:
a frame, wherein said opening is formed on said frame and said optical lens is disposed within said opening;
a light distribution plate disposed at a side of said frame to cover said opening; and
a reflector disposed at another side of said frame opposite to said light distribution plate, wherein said light source is disposed within said reflector.

13. The portable electronic device as claimed in claim 12, wherein said reflector comprises:
a dented portion, wherein said light source is disposed within said dented portion; and
a plurality of expansion portions expansion outwards from said dented portion to said frame.

14. The portable electronic device as claimed in claim 12, wherein said light distribution plate is a Fresnel lens.

15. The portable electronic device as claimed in claim 8 being a digital camera, a digital video camera or a camera cell phone.

16. The portable electronic device as claimed in claim 8, wherein said transmitted illumination beam transmitted through said optical lens has a first irradiation angle when said zoom lens is zoomed in to a wide end and a second irradiation angle when said zoom lens is zoomed out to a tele end, and said first irradiation angle is larger than said second irradiation angle.
